(19) United States
(12) Patent Application Publication
(10) Pub. No.: US 2026/0025419 A1
(43) Pub. Date: Jan. 22, 2026

(54) METHOD AND APPARATUS TO VALIDATE ENABLED FEATURES IN DEVICES AT INITIAL REGISTRATION

(71) Applicant: AT&T Intellectual Property I, L.P., Atlanta, GA (US)

(72) Inventors: Chaoxin Qiu, Austin, TX (US); Min Lu, Holmdel, NJ (US); Eric Ashby, Batavia, IL (US)

(73) Assignee: AT&T Intellectual Property I, L.P., Atlanta, GA (US)

(21) Appl. No.: 18/776,925

(22) Filed: Jul. 18, 2024

(51) Int. Cl. H04L 65/1073; H04L 65/1016

(52) U.S. Cl. CPC H04L 65/1073; H04L 65/1016

(57) ABSTRACT

Aspects of the subject disclosure may include, for example, receiving, over a network, a registration request (e.g., an IMS registration request) from a communication device; obtaining, by the network device over the network from a network server, information indicating enabled services associated with the communication device; and providing, by the network device over the network, a request successful message to the communication device, where the request successful message includes the information indicating the enabled services. Other embodiments are disclosed.

### FIELD OF THE DISCLOSURE

The subject disclosure relates to a method and apparatus to validate enabled features in devices at initial registration.

### BACKGROUND

The type of communication device, as well as other factors, can have an impact or otherwise determine the particular service or application features that a network will provide to the communication device. As an example, Internet of Things (IoT) devices are not intended to utilize Short Messaging Service over Internet Protocol (SMS-over-IP) services. If an IoT device was mistakenly configured (e.g., when the device Original Equipment Manufacturer (OEM) vendor ships the devices to customers) with an SMS-over-IP service or application feature enabled then the network can receive a request for an unsupported service. For instance, after such an IoT device successfully registers with an IP multimedia subsystem (IMS) network, and when a user tries to send an SMS message, the IoT device would attempt to send the SMS message on the IMS network. However, the request would be rejected by an IP messaging server. In this case, the device would not be able to fall back to use SMS on Non-Access Stratum (NAS) and thus the messaging service would not work on the IoT device.

Misalignment between an in-device setting and an in-network subscriber account provisioning is an ongoing service provider challenge. Particularly with hundreds of millions of devices from various device vendors in a service provider network, processing unsubscribed/unsupported feature requests from devices can waste significant network resources. Additionally, if such a problem is exploited by malicious actors, it could cause network system overload and impact normal services.

In practice, network operators generally rely on manual processes, including subscriber account auditing, monitoring on interactions between device and network, such as error response signatures in SIP signaling, call detailed records, internal logs in network element, and so forth. These processes are time consuming and reactive, such as when a misalignment significantly impacts subscriber services or network performance.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B is a block diagram illustrating an example, non-limiting embodiment of a system functioning within the communication network of FIG. 1 in accordance with various aspects described herein.

FIG. 2C depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for utilizing a communication device registration process to verify and/or adjust application features that the communication device is intended to (and/or authorized to) use over the network in order to avoid the communication device requesting services and/or applications features from the network that are not supported by the network for that particular communication device. Other embodiments are described in the subject disclosure.

In one or more embodiments, methods and systems are provided that allow network devices, such as an IMS Serving Call Session Control Function (S-CSCF), to utilize the IMS registration process to validate application features that are enabled in devices. For example, when an IMS subscriber is provisioned in an IMS Home Subscriber Server (HSS), the subscriber profile can include an explicit list of application features that are intended to be enabled for the subscriber's device(s). As another example, when an IMS device requests an initial IMS registration, the device can include a list of enabled service feature capability, such as in the Session Initiation Protocol (SIP) contact header within the SIP REGISTER message. As another example, when the IMS authentication is successful, the S-CSCF can send a Diameter Cx Server Assignment Request (SAR) to the HSS. The HSS will then respond with the Server Assignment Answer (SAA), and the HSS can include the list of services or application features for the subscriber device in the SAA message.

In one embodiment, the S-CSCF may include a list of services or application features in a new SIP header (e.g., an X-feature-list) in a SIP 200 OK response sent to the communication device based on the device registration request from the communication device. For example, the communication device can then compare the received list with its local configuration to fix feature settings (e.g., enable or disable services or application features that are network supported accordingly). In one embodiment, one, some or all communication devices can be required to include a complete feature list in their contact header when requesting an initial registration. In this example, the S-CSCF may compare a provisioned list of application features received or obtained from the HSS with the list of the application features in the communication device contact header. The S-CSCF may then remove those application features in the device contact header if those application features are not supported or authorized based on the provisioned list of application features received from the HSS.

In one embodiment, leveraging of subscriber data (e.g., stored in or provisioned to the network) in conjunction with a registration process (or other verification technique) can be used to validate particular application features that are enabled in particular devices (and avoid requests being made for unsupported application features) in other network configurations or architectures, such as a Service-Based Interface (SBI) architecture. For example, the SBI architecture can provide an interface through which different network functions and services can interact and communicate to provide services to communication devices. This interfacing can be done in a number of different ways including via HTTP/2 for real-time and low-latency operations. For example, a Unified Data Management (UDM) can provide storage and management of subscriber data including enabled or supported services information (e.g., a list of enabled application features) associated with particular communication devices. For instance, the UDM can be provisioned with the information indicating the enabled services during, or in association with, a service ordering/provisioning process for the communication device, such as for a subscriber account, prior to a registration request by the communication device.

In one embodiment, the UDM can expose an N70 interface to allow an Application Function (AF) to retrieve relevant data for customized or personalized services. In one embodiment, the N70m interface can be utilized to obtain the known enabled or supported services information (e.g., supported application features) from the UDM so that it can be compared to potential application features in the communication device's configuration. This comparison can allow the communication device to perform a reconfiguration so that only supported application features are requested.

The methods and systems described herein can be utilized to prevent communication devices from requesting unsupported (or unsubscribed) application features after a registration, such as an IMS registration. This can save network workload for such requests that will or could be rejected, and further avoids wasting network resources for unnecessary processing of such requests. The methods and systems described herein can assist service providers, operators and/or device OEM vendors in maintaining proper device auto-configuration for services and application features. The methods and systems described herein can also prevent or reduce malicious devices from launching a large number of unsupported application feature requests against an IMS network, which is a possible form of DOS/DDOS attack.

One or more aspects of the subject disclosure include a network device, comprising: a processing system including a processor; and a memory that stores executable instructions that, when executed by the processing system, facilitate performance of operations. The operations can include receiving, over a network, an IMS registration request from a communication device. The network device can obtain, over the network from a network server, information indicating enabled services associated with the communication device. The network device can provide, over the network, a request successful message to the communication device, where the request successful message includes the information indicating the enabled services.

One or more aspects of the subject disclosure include a non-transitory machine-readable medium, comprising executable instructions that, when executed by a processing system including a processor of a communication device, facilitate performance of operations. The operations can include providing, over a network, a registration request; receiving, over the network, a request successful message, where the request successful message includes information indicating enabled services associated with the communication device; and disabling an application feature according to the information indicating the enabled services.

One or more aspects of the subject disclosure include a method comprising receiving, by a network device over a network, a registration request from a communication device. The method can include obtaining, by the network device over the network from a network server, information indicating enabled services associated with the communication device, where the information indicating the enabled services includes identification of application features authorized for the communication device, and where the network server is provisioned with the information indicating the enabled services according to a service ordering process associated with the communication device for a subscriber account prior to the receiving of the registration request. The method can include providing, by the network device over the network, a request successful message to the communication device, where the request successful message includes the information indicating the enabled services.

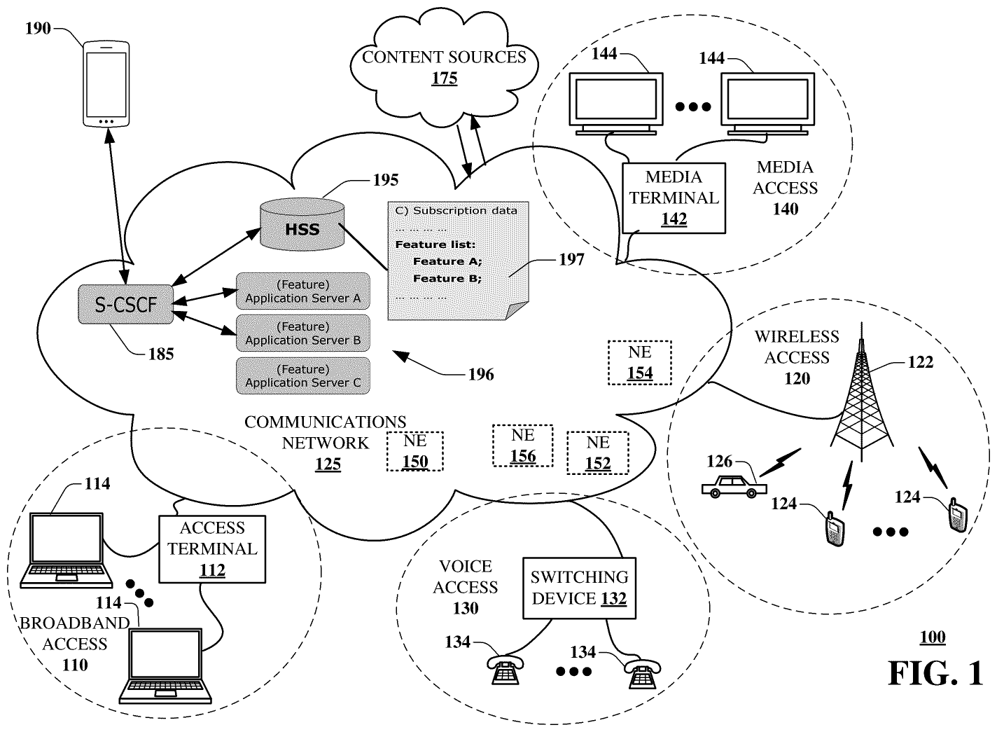

Referring now to FIG. 1, a block diagram is shown illustrating an example, non-limiting embodiment of a system 100 in accordance with various aspects described herein. System 100 can include a network device 185 (e.g., an S-CSCF) that receives a registration request from a communication device 190 (e.g., a UE such as a mobile phone). It should be understood that the communication device 190 can be various types of devices, including other devices that are illustrated in FIG. 1.

The network device 185 can obtain, from a network server 195 (e.g., an HSS), information indicating enabled services (e.g., Feature A and Feature B) associated with the communication device 190. As an example, the information can indicate enabled services that are supported by the network or service provider, such as application features authorized for the communication device 190. It should be understood that the enabled services or features can be various types of services or features described with respect to FIG. 1.

In one embodiment, the network server 195 (e.g., the HSS or other server(s)) can be provisioned with information 197 indicating the enabled services. For instance, this provisioning can occur during, or in association with, a service ordering/provisioning process for the communication device, such as for a subscriber account, prior to the network device 185 receiving the registration request.

The network device 185 can provide a response, such as a registration request successful message, to the communication device 190, where the response includes the information indicating the enabled services of application servers 196 (e.g., Features A and B of application servers A and B, but not Feature C of application server C according to the subscription data 197 stored at the HSS 195). This information 197 then allows the communication device 190 to disable or otherwise prevent requesting application features from the network that are not supported by, or otherwise not enabled by, the network.

In one embedment, the S-CSCF 185 may include the list of application features in a new SIP header (e.g., X-Feature-List) in a SIP 200 OK response to the device registration request. The device 190 can compare the list with its local configuration to fix feature settings (e.g., enable or disable accordingly).

In one embodiment, some or all devices (such as device 190) can be required to include a complete feature list in its contact header when requesting an initial registration. The S-CSCF 185 may compare the list of application features received from the HSS 195 with the list of the features in the device contact header. The S-CSCF 185 may remove those features in the device contact header if these features are not supported based on the list of application features received from HSS 195.

For example, system 100 can facilitate in whole or in part receiving, over a network, a registration request (e.g., an IMS registration request) from a communication device; obtaining, by the network device over the network from a network server, information indicating enabled services associated with the communication device; and providing, by the network device over the network, a request successful message to the communication device, where the request successful message includes the information indicating the enabled services.

In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

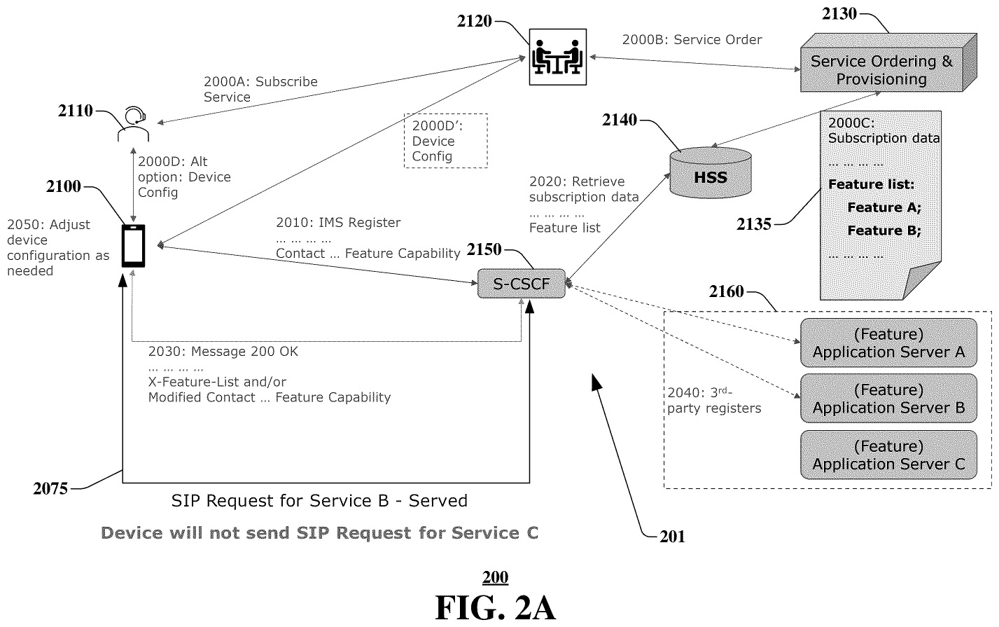

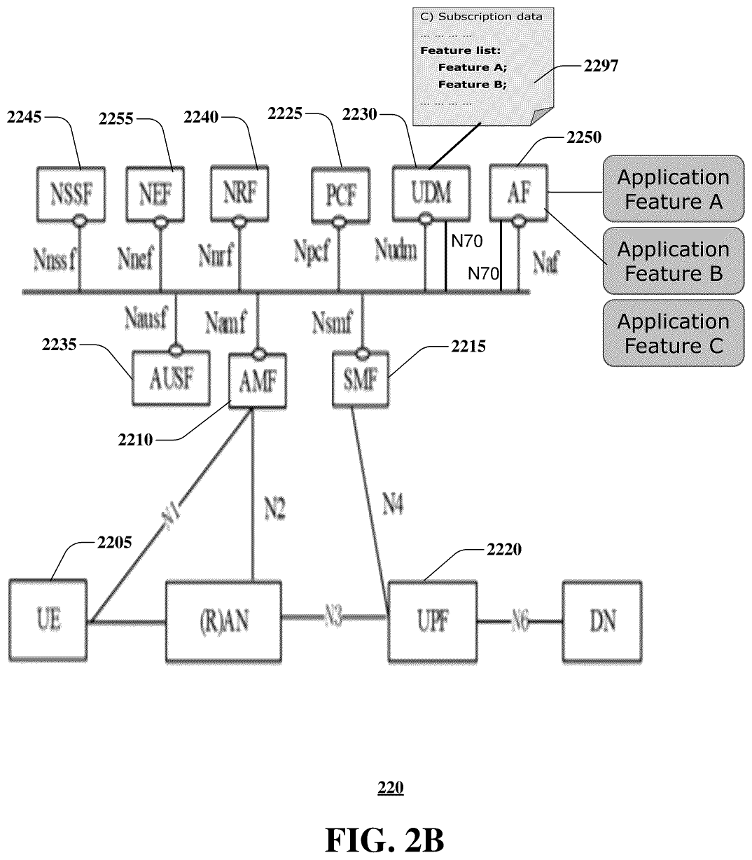

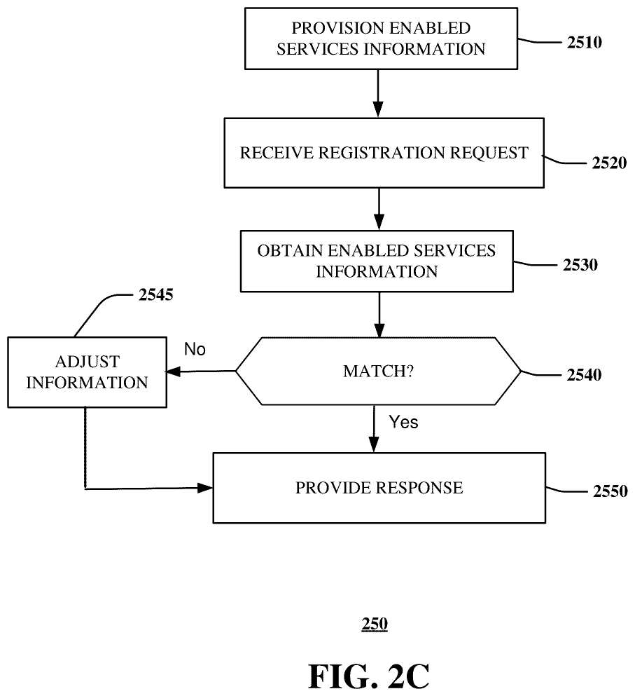

FIG. 2A is a block diagram illustrating an example, non-limiting embodiment of a system 200 functioning within the communication network of FIG. 1 in accordance with various aspects described herein. System 200 includes a network 201 with various components, such as a network server (e.g., HSS 2140) and a network device (e.g., S-CSCF 2150). Various other components and/or procedures can be utilized (which are not shown) for delivering communication services to communication devices of various types including end user devices, IoT devices, and so forth. System 200 illustrates an example network that can perform an IMS registration. In other embodiments, the network and/or registration can be of other types.

System 200 allows for service ordering and provisioning for communication devices. For example, at 2000A, a user 2110 can subscribe to services from a service provider for a communication device 2100. Device 2100, which is illustrated as a smartphone, can be of various types including mobile phones, laptop computers, desktop computers, IoT devices and other devices capable of communicating over a network and/or providing one or more communication services.

The service subscription for device 2100 can be done in a number of different ways including communicating with a service provider office, provider store, or administrator system 2120. As an example, the service ordering and provisioning can include a service order at 2000B which is communicated to a service ordering and provisioning server or system 2130. This causes the server 2130 at 2000C to provision the HSS 2140 (or other subscriber information depository) with subscription data 2135. The subscription data 2000C includes information indicating enabled services for the communication device. As an example, the enabled services can be application features or services that the network will provide to the communication device such as various types of voice, video, audio, data, and/or messaging. Various other steps can also be utilized as part of the provisioning and activating of a particular device 2100.

In one embodiment, the provisioning at 2000C can involve provisioning of a subscriber account (e.g., including the subscription data 2135) to a number of network systems, which can include the provisioning of the HSS 2140. In one embodiment, when a subscriber account is provisioned to the HSS 2140 at 2000C, a list of explicitly defined features is added to the subscription data. This list can be of enumerated specific application features that a subscriber (device) is intended to use.

Based on the provisioning of the information indicating the enabled services and application features for the particular communication device 2100 to the HSS 2140, system 200 can leverage device registration to monitor for and/or reduce or eliminate requests for unsupported services or application features.

System 200 illustrates a simplified device IMS registration process. Various other techniques and devices can be utilized as part of the registration process, including additional steps, messaging, or call flows being utilized to register a communication device with a network. For example, call flow details of IMS registration are defined by 3GPP (e.g., ref. 3GPP Technical Specification 24.229), which are incorporated herein by reference. System 200 can utilize the IMS registration processes and components to verify and/or adjust application features that a communication device is intended to (and/or authorized to) use over a network in order to avoid the communication device requesting services and/or applications features from the network that are not supported by the network for that particular communication device.

In one embodiment at 2010, when an IMS device (e.g., device 2100) requests an initial IMS registration, the device can include a list of enabled services/features capability. For example, this information can be included in the SIP contact header in the SIP REGISTER message. Various other call flows and messaging can occur, such as to provide for an authentication of the device 2100. In one embodiment, the requirement of 2010 of providing a list of enabled services/features capability for the device can be mandatory and result in rejection of the registration request. However, in other embodiments, the requirement of 2010 of providing a list of enabled services/features capability for the device can be optional and can result in the registration request still being processed. This optional technique may facilitate legacy devices registering with the network and having their local list of enabled services/features capability reconfigured as described herein.

At 2020, when, or responsive to, the IMS authentication being successful, S-CSCF 2150 can obtain information indicating enabled services for the device 2100. For example, the S-CSCF can send a Diameter Cx SAR to HSS 2140. The HSS 2140 can respond with an SAA message. The SAA message can include a list of enabled services (e.g., application features) for the subscriber account. The S-CSCF 2150 can cache or otherwise store the subscriber profile, including the enabled services/application feature list. Other messaging techniques can also be utilized by the S-CSCF (or other network server) for obtaining information indicating enabled services for the device 2100, although adding the information to existing messaging schemes performed by the network may be more efficient.

At 2030, the S-CSCF 2150 can format the information for transmitting to the device 2100 in order to allow the device 2100 to be advised as to the enabled services or applications features for the device 2100. As an example, the S-CSCF 2150 can include the list of application features in a new SIP header (e.g., X-Feature-List) in the SIP 200 OK response to the device registration request. For instance, this may be more effective for legacy devices that have not provided the local list of enabled services/features capability at 2010 with the registration request.

In another embodiment (at 2030), if the device 2100 has provided the necessary information at 2010 (e.g., the device 2100 has included a complete feature list such as in its contact header when requesting an initial registration) then the S-CSCF 2150 can compare the list of application features received from the HSS 2140 with the list of the features in the device contact header. In this example, the S-CSCF 2150 can remove any features in the device contact header if those features are not supported based on a comparison with the list of enabled services/application features received from HSS 2140. In one embodiment at 2040, third-party registration 2160 can be employed as an implementation choice of an application server.

At 2050, the device 2100 can perform a “true up” or reconfiguration for its device feature capability configuration according to the list of enabled services/application features received from the S-CSCF 2150 (or other network server). For example, the device 2100 can receive a 200 OK response from the S-CSCF 2150 and can analyze the X-Feature-List or the returned contact header received therein to compare the application feature list with its local feature enablement configuration. The device 2100 can then disable application features/services that the network indicates it does not support (e.g., not included in the list of enabled services/application features).

At 2075, service request messaging can be performed. For example, device 2100 can transmit a SIP Request for service/feature B to the network since service/feature B is included in the subscription data 2135 and would have been included in the list of enabled services/application features received from the S-CSCF 2150. However, device 2100 would not have transmitted a SIP Request for service/feature C to the network since service/feature C was not included in the subscription data 2135 and would not have been included in the list of enabled services/application features received from the S-CSCF 2150. In this example, the device 2100 would have received a 200 OK response from the S-CSCF 2150 and would have analyzed the X-Feature-List or the returned contact header received therein to compare the application feature list with its local feature enablement configuration so that the device 2100 could then disable application feature/service C that the network indicates is not supported (e.g., not included in the list of enabled services/application features). Thus, device 2100 would not have transmitted a SIP Request for service/feature C to the network. Further to this example if feature A had been requested by the device 2100, it would have been approved since it is also in the list of enabled services/application features stored by the HSS 2140.

In a contemporary network, a SIP Request for service C would have been transmitted even though it is not supported. This would have resulted in a rejection by the S-CSCF or by app server C. Additionally, devices typically repeat such requests which would further create unwanted messaging in the contemporary network. The exemplary embodiments described herein avoid this unwanted messaging and processing since a device is sending requests for services or features that are supported and that should be approved.

In one or more embodiments, the systems and functions described herein can be applied in a large service provider network by establishing alignment between the network and device (e.g., vendors) for standard vocabulary of application feature names. As an example, 3GPP maintains a list of registered Uniform Resource Names (URNs) for IMS Communication Service Identifier (ICSI) and IMS Application Reference Identifier (IARI). Examples of Uniform Resource Identifier (URI) from the list (3gpp.org) include +g.3gpp.icsi-ref=“urn%3Aurn-7%3A3gpp-service.ims.icsi.mmtel” and +g.3gpp.iari-ref=“urn%3Aurn-7%3A3gpp-application.ims.iari.rcse.dp”.

Devices can include unregistered feature terms that may not be standardized and may not be recognized across all entities in a service provider ecosystem; for example: “audio”, “text”, “video”. The URNs registered by 3GPP may be long in terms of character counts. When many URNs are used together, the SIP header could become large and may be challenging to some existing network functions. In one or more embodiments, the systems and functions described herein can utilize service provider's OEM device requirement specifications to tailor the 3GPP URNs and/or can implement the information indicating the enables application features/services for a subset of the most often utilized application service features. In one embodiment, terms can be utilized to represent multiple services/application features that are used together.

As described herein in one or more embodiments, the communication device can act on, or otherwise adjust its device configuration according to, a received SIP 200 OK message. This can cause adjusting the feature configuration for the communication device (and adjusting the features/services being requested over the network) based on the received information indicating the enabled services/features for the communication device, such as in an X-feature-list or in a modified contact header. In one or more embodiments, the systems and functions described herein can be implemented based on methodology and terminology that is standardized, such as placed in a communications standard (e.g., 3GPP). However, prior to such standardization, in one or more embodiments, the systems and functions described herein can be implemented by utilizing service provider's OEM device requirement specification. In one or more embodiments, the systems and functions described herein can use an X-feature-list to avoid unexpected device negative reactions to a network-modified contact header. However, in other embodiments, the information associated with the enabled services for the communication device can be placed into the contact header of the response message sent to the communication device upon initial registration.

In one or more embodiments, the systems and functions described herein can provide a method (e.g., automatic) to align device feature capability with the device's account provisioning in the service operator network. In one or more embodiments, the systems and functions described herein can avoid accidental service problems due to the misalignment between device configuration and account provisioning in the network. In one or more embodiments, the systems and functions described herein can save network resources on wasted handling of unsupported service requests. In one or more embodiments, the systems and functions described herein can prevent or reduce malicious attacks which could be caused by launching a large number of unsupported service requests.

In one or more embodiments, the systems and functions described herein can be implemented with and/or on behalf of various communication services and service providers who use communications (including IMS) such as for VoLTE, 5G VoNR, or IoT services.

In one or more embodiments, the exemplary techniques can be applied to an IMS Core, where IoT devices are not intended to use SMS-over-IP. The exemplary embodiments can manage IoT devices that were configured mistakenly with the SMS-over-IP feature enabled, such as when a device OEM vendor mistakenly shipped the devices to customers.

Upon the IoT device registering with the IMS network, steps 2020-2050 described with respect to system 200 can be performed in order to reconfigure the local feature enablement configuration of the IoT device and so that the IoT device can then disable application features/services that the network indicates are not supported (e.g., not included in the list of enabled services/application features).

System 200 can mitigate any misalignment between in-device settings and in-network subscriber account provisioning. With hundreds of millions of devices from various device vendors in a service provide network, system 200 can avoid transmitting and processing unsubscribed/unsupported feature requests from devices which would be a waste of significant network resources. Additionally, system 200 can prevent, reduce or mitigate this being exploited by malicious players, where they try to use such messaging to cause network system overload and impact normal services.

System 200 provides a more efficient way of managing and avoiding messaging for unsupported services/features as opposed to network operators relying on manual processes, including subscriber account auditing, monitoring on interactions between device and network, such as error response signatures in SIP signaling, call detailed records, internal logs in network element.

In one or more embodiments, updates to the enabled services and enabled application features can be provisioned to the network server or HSS 2140. Updated provisioning can be performed based on changes to a subscriber account, changes to provider policies, and/or other changes that effect services that a device is expected to provide including changes to an Industry Standard (e.g., 3GPP), jurisdictional rules and regulations, and so forth.

FIG. 2B is a block diagram illustrating an example, non-limiting embodiment of a system 220 functioning within the communication network of FIG. 1 in accordance with various aspects described herein. System 220 can operate via a SBI architecture that enables different network functions and services to interact to provide services, such as communication device 2205. In one embodiment, system 220 can utilize protocols, such as HTTP/2, for real-time and low-latency operations. System 220 can leverage a registration process (or other verification technique) in conjunction with subscriber data stored in the network to validate particular application features that are enabled in particular devices and avoid requests being made by the communication device for unsupported application features.

System 220 can operate utilizing various hardware, software, and other components and/or procedures which operate as, or communicate with, network functions for delivering communication services to communication devices of various types including end user devices, IoT devices, and so forth. System 220 illustrates an example network that can perform a registration for the communication device 2205.

In one embodiment, system 220 can include a UDM 2230 which can provide storage and management of subscriber data, and which can be a centralized path or technique to process network user data to provide services for various other network functions. The UDM 2230 also can provide services such as authorization of accessing, registration, and/or uninterrupted services.

The UDM 2230 can be a central repository for subscriber-related data, including authentication credentials, subscription profiles, and service entitlements, and can manage or maintain user identities, security context, and session-related information. The information stored by the UDM 2230 can include enabled services information 2297 (e.g., Application Feature A and Application Feature B) associated with the communication device 2205. As an example, the information 2297 can indicate enabled services that are supported by the network or service provider, such as application features authorized for the communication device 2205. It should be understood that the enabled services or features can be various types of services or features. In one embodiment, the UDM 2230 can be provisioned with the information 2297 indicating the enabled services. For instance, this provisioning can occur during, or in association with, a service ordering/provisioning process for the communication device 2205, such as for a subscriber account, prior to a registration request by the communication device.

In one embodiment, the UDM 2230 can expose the N70 interface to allow Application Function (AF) 2250 to retrieve relevant data for customized or personalized services. For example, the AF 2250 can act as one or more application servers and can represent, operates as, or otherwise provide access to, various applications and services within the network, including interacting with subscribers, providing context-aware services based on their preferences, location, and subscription profiles. The AF 2250 can be a functional element that provides service- or application-related information to NF service consumers, and can allow network function service consumers to subscribe to and unsubscribe from periodic notifications and/or notifications related to the detection of subscribed events. In one embodiment, system 220 can utilize the N70 interface between the UDM 2230 and the AF 2250 within the network architecture, in order to enable the AF to access subscriber-related information and services managed by the UDM. In one embodiment, the AF 2250 utilizes the N70 interface to query the UDM 2230 for specific subscriber information needed to deliver customized or personalized services.

As an example, the N70 interface facilitates service personalization, where the AF 2250 can retrieve user preferences, service subscriptions, and context information from the UDM 2230 to customize or adjust services (e.g., location-based services). As another example, the N70 interface facilitates authentication and authorization, where the AF 2250 can verify user identities and access rights by querying the UDM 2230. As yet another example, the N70 interface facilitates service continuity, where the AF 2250 can retrieve session-related data from the UDM 2230 to maintain service continuity, such as during handovers or session transfers.

In one embodiment utilizing an SBI architecture, various functionalities can be performed or achieved through RESTful API calls over the N70 interface, employing HTTP/2 methods like GET, POST, PUT, and DELETE to manage sessions and subscriber data. In one embodiment, the RESTful API calls over the N70 interface can enable accessing information 2297 indicating enabled/supported services and application features for the particular communication device 2205.

Based on the provisioning of the information 2297 indicating the enabled services and application features for the particular communication device 2205 to the UDM 2230, system 220 can leverage device registration to monitor for and/or reduce or eliminate requests for unsupported services or application features. It should be understood that the type of messaging performed by system 220 in order to compare known enabled features information 2297 (e.g., stored by the UDM 2230) with features that the communication device 2205 may potentially request (e.g., configured at the communication device) prior to the request for such application features being transmitted over the network can vary. It should also be understood that various network functions (including those illustrated in FIG. 2B) can access the known enabled application feature information (stored in UDM 2230) and/or perform the comparison between the known application feature information and the potential features associated with the configuration of device 2205. Thus, leveraging of a network verification technique in conjunction with subscriber data stored in the network to validate particular application features can be performed by different network functions via different messaging, one of which is a registration process and its associated messaging.

In one embodiment, device 2205 (e.g., as part of a registration process) can be advised as to the enabled services or applications features (Application Features A and B but not Application Feature C). For instance, a list of application features in a new SIP header (e.g., X-Feature-List) can be provided or if the device 2205 has provided the necessary information (e.g., the device has included a complete feature list such as in its contact header when requesting an initial registration) then the list of application features known to the UDM 2030 can be compared with the list of features in the device contact header. In this example, any application features in the device contact header can be removed if those features are not supported based on the comparison. In one embodiment, the device 2205 can perform a “true up” or reconfiguration for its device feature capability configuration according to the list of enabled services/application features.

System 220 can include other network functions including an Access and Mobility Management Function (AMF) 2210 which can manage access and mobility for UEs; a Session Management Function (SMF) 2215 which can perform session management and control; a User Plane Function (UPF) 2220 which can perform user plane packet routing and forwarding; a Policy Control Function (PCF) 2225 which can manage policy and charging control aspects; an Authentication Server Function (AUSF) 2235 which can perform authentication of users; and a Network Repository Function (NRF) 2240 which can maintain information about the available services within the network. In one embodiment, system 220 can include a Network Slice Selection Function (NSSF) 2245 which facilitates customized end-to-end slices with specific capabilities and service level agreements such as through selection of a network slice instance based on the Single Network Slice Selection Assistance Information (S-NSSAI) identifier, which can include ensuring that the UE 2205 is associated with the correct slice, considering the UE's subscription and service requirements. In one embodiment, system 220 includes a Network Exposure Function (NEF) 2255 which is an interface between the network infrastructure and external entities and allows external applications to interact with the network by exposing specific services and capabilities, including requesting connectivity services; enforcing policies related to network access, data usage, and resource allocation; and controlling access to subscriber-related information. System 220 can include other components and functionality, including a RAN and Data Network.

FIG. 2C depicts an illustrative embodiment of a method 250 in accordance with various aspects described herein. At 2510, services information can be provisioned to the network for a particular device, group of devices, subscriber and so forth. As an example, the services information can include services or application features that are supported by the network, and/or enabled or otherwise authorized for the particular device(s). This can be based on a number of criteria including the type of device (e.g., an IoT device vs. a mobile phone), a user subscription plan, Service Provider policies, and so forth.

In one embodiment, the communication device can be an end user device, where the services information indicates the enabled services includes identification of application features authorized for the communication device. In one embodiment, the provisioning can include an HSS or other server being provisioned with the information indicating the enabled services, such as according to a service ordering process associated with the communication device for a subscriber account. In one embodiment, the communication device can be an IoT device (e.g., a vehicle sensor, security monitoring, device, and so forth) or other type of device that is intended to have limits placed on its service capability (e.g., a device that is not permitted to utilized SMS services). In one or more embodiments, the enabled services information can be provisioned as a part of the subscriber account subscription, or as a follow-up add-on to existing subscriber account subscription.

At 2520, the communication device can attempt to register with a network. For instance, a network device (e.g., an S-CSCF) can receive, over the network, an IMS registration request from the communication device. At 2530, this can cause the network device to obtain the enabled services information corresponding to the particular communication device. For instance, an S-CSCF can obtain the enabled services information from the HSS that had previously been provisioned with such information.

In one embodiment at 2540, method 250 can compare the provisioned enabled services information associated with the communication device against services information received from the communication device with the registration request (e.g., device configuration data). In one embodiment, the device configuration data can be included in a contact header of the registration request message. As an example, this comparison can be performed by the S-CSCF based on the provisioned enabled services information obtained from the HSS. If a match is determined (e.g., the received enabled services are the same as or are included in the provisioned services and application features) then at 2550 a response to the registration request can be provided to the communication device without reconfiguration of the device configuration data known to (e.g., stored by) the communication device. For example, an S-CSCF can provide a SIP 200 OK message to the communication device. If on the other hand there is a discrepancy between the provisioned enabled services information associated with the communication device and the device configuration data received with the registration request then the information can be adjusted at 2545 (e.g., removing any services/features that are not supported by the network for this device). The adjusted enabled services information can then be provided to the communication device along with the response to the request (e.g., the SIP 200 OK message or other success response message). In one embodiment, the device can then reconfigure its local version of the enabled features/services so as to avoid requesting unsupported features/services from the network.

In one embodiment, a service request can be received by a network device (e.g., an S-CSCF) from a communication device, where the service request is for an enabled service, and where the service request is generated by the communication device after the communication device adjusts a local communication device configuration according to information indicating enabled services that is received from the network device.

In one embodiment, receiving an IMS registration request by a network device from the communication device includes receiving device configuration data indicating service capability of the device, where the network device adjusts the device configuration data to match the enabled services (received from the network server such as an HSS) resulting in adjusted device configuration data, and where the network device transmits to the communication device information indicating the enabled services in a request successful message that includes the adjusted device configuration data.

In one embodiment, the device configuration data is included in a header of the IMS registration request. In one embodiment, the adjusted device configuration data is included in a header of the request successful message. In one embodiment, the S-CSCF inserts the information indicating the enabled services in a header of the request successful message. In one embodiment, the information indicating the enabled services is derived from terminology representing application features associated with different vendors that correspond to a subset of 3GPP Uniform Resource Names (URNs).

While for purposes of simplicity of explanation, the respective processes are shown and described as a series of blocks in FIG. 2B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

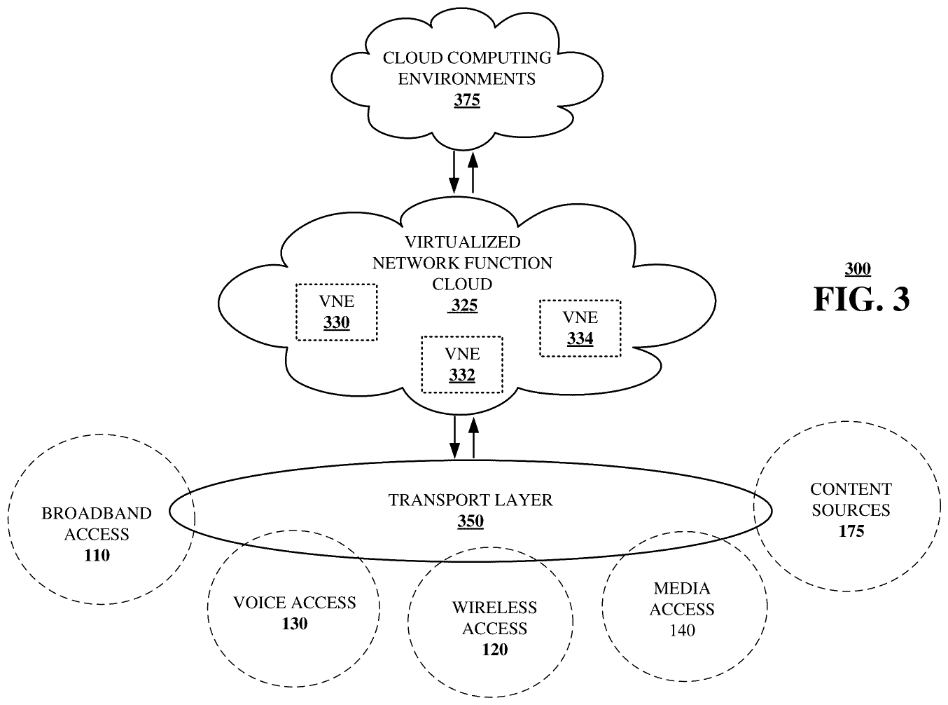

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200, and method 230 presented in FIGS. 1, 2A, 2B, 2C and 3. For example, virtualized communication network 300 can facilitate in whole or in part receiving, over a network, a registration request (e.g., an IMS registration request) from a communication device; obtaining, by the network device over the network from a network server, information indicating enabled services associated with the communication device; and providing, by the network device over the network, a request successful message to the communication device, where the request successful message includes the information indicating the enabled services.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

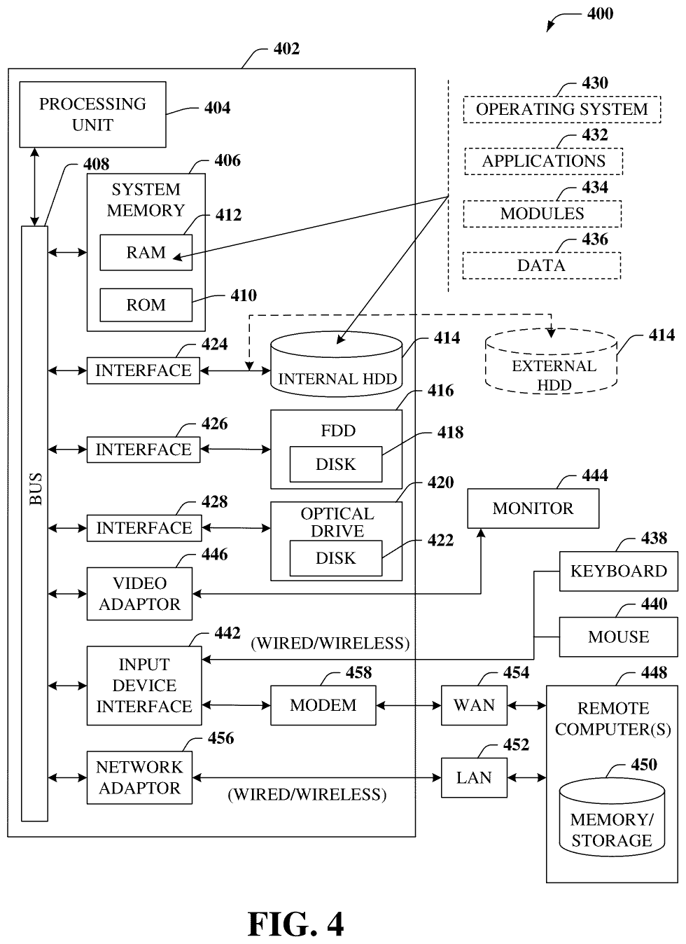

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part receiving, over a network, a registration request (e.g., an IMS registration request) from a communication device; obtaining, by the network device over the network from a network server, information indicating enabled services associated with the communication device; and providing, by the network device over the network, a request successful message to the communication device, where the request successful message includes the information indicating the enabled services.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

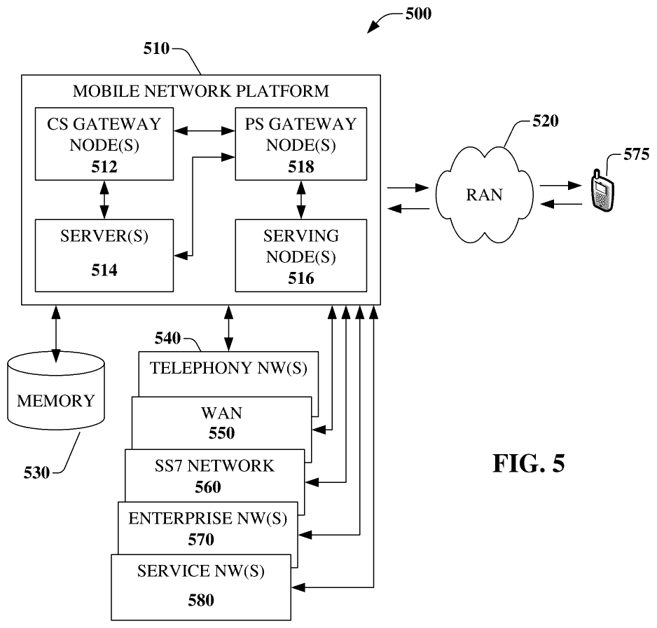

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part receiving, over a network, a registration request (e.g., an IMS registration request) from a communication device; obtaining, by the network device over the network from a network server, information indicating enabled services associated with the communication device; and providing, by the network device over the network, a request successful message to the communication device, where the request successful message includes the information indicating the enabled services. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

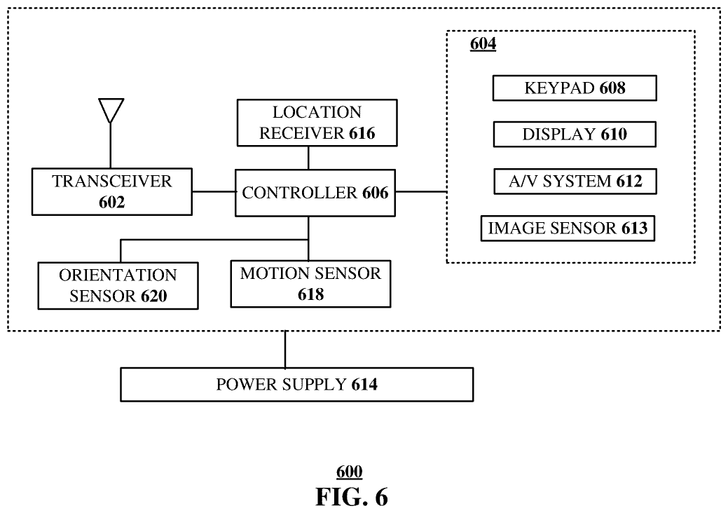

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part receiving, over a network, a registration request (e.g., an IMS registration request) from a communication device; obtaining, by the network device over the network from a network server, information indicating enabled services associated with the communication device; and providing, by the network device over the network, a request successful message to the communication device, where the request successful message includes the information indicating the enabled services.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A network device, comprising:
a processing system including a processor; and
a memory that stores executable instructions that, when executed by the processing system, facilitate performance of operations, the operations comprising:
receiving, over a network, an IP multimedia subsystem (IMS) registration request from a communication device;
obtaining, over the network from a network server, information indicating enabled services associated with the communication device; and
providing, over the network, a request successful message to the communication device, wherein the request successful message includes the information indicating the enabled services.

2. The network device of claim 1, wherein the operations further comprise receiving, over the network, a service request from the communication device, wherein the service request is for a service of the enabled services, and wherein the service request is generated by the communication device after the communication device adjusts a communication device configuration according to the information indicating the enabled services.

3. The network device of claim 1, wherein the receiving the IMS registration request from the communication device includes receiving device configuration data indicating service capability, wherein the operations further comprise adjusting the device configuration data to match the enabled services resulting in adjusted device configuration data, and wherein the information indicating the enabled services included in the request successful message is the adjusted device configuration data.

4. The network device of claim 3, wherein the device configuration data is included in a header of the IMS registration request.

5. The network device of claim 3, wherein the adjusted device configuration data is included in a header of the request successful message.

6. The network device of claim 1, wherein the operations further comprise inserting the information indicating the enabled services in a header of the request successful message.

7. The network device of claim 1, wherein the network device operates as a Serving Call Session Control Function (S-CSCF), and wherein the network server is a Home Subscriber Server (HSS).

8. The network device of claim 7, wherein the communication device is an end user device, wherein the information indicating the enabled services includes identification of application features authorized for the communication device, and wherein the HSS is provisioned with the information indicating the enabled services according to a service ordering process associated with the communication device for a subscriber account prior to the receiving of the IMS registration request.

9. The network device of claim 1, wherein the information indicating the enabled services is derived from terminology representing application features associated with different vendors that correspond to a subset of 3GPP Uniform Resource Names (URNs).

10. A non-transitory machine-readable medium, comprising executable instructions that, when executed by a processing system including a processor of a communication device, facilitate performance of operations, the operations comprising:
providing, over a network, a registration request;
receiving, over the network, a request successful message, wherein the request successful message includes information indicating enabled services associated with the communication device; and
disabling an application feature according to the information indicating the enabled services.

11. The non-transitory machine-readable medium of claim 10, wherein the information indicating the enabled services associated with the communication device is obtained from a unified data management function that exposes an N70 interface for accessing the information, and wherein the operations further comprise:
adjusting of a communication device configuration according to the information indicating the enabled services resulting in the disabling of the application feature; and
providing, over the network, a service request for a service of the enabled services.

12. The non-transitory machine-readable medium of claim 10, wherein the providing of the registration request includes providing device configuration data indicating service capability of the communication device.

13. The non-transitory machine-readable medium of claim 12, wherein the device configuration data is included in a header of the registration request.

14. The non-transitory machine-readable medium of claim 10, wherein the information indicating the enabled services is included in a header of the request successful message.

15. The non-transitory machine-readable medium of claim 10, wherein the request successful message is received from a network device operating as a Serving Call Session Control Function (S-CSCF), and wherein the S-CSCF obtains, over the network from a network server, the information indicating the enabled services associated with the communication device.

16. The non-transitory machine-readable medium of claim 10, wherein the network server is a Home Subscriber Server (HSS), wherein the information indicating the enabled services includes identification of application features authorized for the communication device, and wherein the HSS is provisioned with the information indicating the enabled services according to a service ordering process associated with the communication device for a subscriber account prior to the providing of the registration request.

17. The non-transitory machine-readable medium of claim 10, wherein the information indicating the enabled services is derived from terminology representing application features associated with different vendors that correspond to a subset of 3GPP Uniform Resource Names (URNs).

18. A method, comprising:
receiving, by a network device over a network, a registration request from a communication device;
obtaining, by the network device over the network from a network server, information indicating enabled services associated with the communication device, wherein the information indicating the enabled services includes identification of application features authorized for the communication device, wherein the network server is provisioned with the information indicating the enabled services according to a service ordering process associated with the communication device for a subscriber account prior to the receiving of the registration request; and
providing, by the network device over the network, a request successful message to the communication device, wherein the request successful message includes the information indicating the enabled services.

19. The method of claim 18, further comprising:
receiving, by the network device over the network, a service request from the communication device, wherein the service request is for a service of the enabled services, and wherein the service request is generated by the communication device after the communication device adjusts a communication device configuration according to the information indicating the enabled services.

20. The method of claim 19, wherein the receiving the registration request from the communication device includes receiving device configuration data indicating service capability, and further comprising:
adjusting the device configuration data to match the enabled services resulting in adjusted device configuration data, wherein the information indicating the enabled services included in the request successful message is the adjusted device configuration data.
